(19) United States
(12) Patent Application Publication
(10) Pub. No.: US 2017/0357600 A1
(43) Pub. Date: Dec. 14, 2017

(54) MEMORY DEVICE, MEMORY MODULE, AND OPERATING METHOD OF MEMORY DEVICE

(71) Applicant: Samsung Electronics Co., Ltd., Suwon-si (KR)

(72) Inventor: Sung-up Moon, Seoul (KR)

(21) Appl. No.: 15/604,944

(22) Filed: May 25, 2017

(30) Foreign Application Priority Data
Jun. 8, 2016 (KR) 10-2016-0070997

(51) Int. Cl. G06F 12/123; G06F 12/0891

(52) U.S. Cl. CPC G06F 12/123; G06F 12/0891; G06F 2212/60

(57) ABSTRACT

A memory device, a memory module, and an operating method of the memory device are provided. The memory device includes a cell array storing a plurality of cache lines and a plurality of tags corresponding to the plurality of cache lines, a cache policy setting circuit selecting from a plurality of managing policies at least one managing policy and setting a cache policy based on the at least one selected managing policy, and cache logic managing the plurality of cache lines based on the cache policy.

### CROSS-REFERENCE TO RELATED APPLICATION

This application claims the benefit of priority under 35 USC §119 to Korean Patent Application No. 10-2016-0070997, filed on Jun. 8, 2016, in the Korean Intellectual Property Office, the disclosure of which is incorporated herein in its entirety by reference.

### BACKGROUND

The disclosure relates to a semiconductor memory device, and more particularly, to a memory device and a memory module operating as cache memory, and an operating method of the memory device.

In a computing system, cache memory is used to reduce performance deterioration due to long access latency of main memory. As a capacity of main memory has increased, a capacity of cache memory has also increased. Thus, a memory capable of being realized to have a high capacity, such as dynamic random access memory (DRAM), may be used as cache memory.

### SUMMARY

The disclosure provides a memory device and a memory module dynamically changing a cache policy, and an operating method of the memory device.

According to an aspect of the inventive concept, there is provided a memory device including a cell array storing a plurality of cache lines and a plurality of tags corresponding to the plurality of cache lines, a cache policy setting circuit selecting from a plurality of managing policies at least one managing policy and setting a cache policy based on the at least one selected managing policy, and cache logic managing the plurality of cache lines based on the cache policy.

According to another aspect of the inventive concept, there is provided a memory module including a plurality of first memory devices storing a plurality of cache lines, and a second memory device storing a plurality of cache tags corresponding to the plurality of cache lines, selecting from a plurality of managing policies at least one managing policy as a cache policy, and managing the plurality of cache lines based on the cache policy and the plurality of cache tags.

According to another aspect of the inventive concept, there is provided an operating method of a memory device, the operating method including managing a plurality of cache lines based on a pre-set cache policy, changing the cache policy by selecting from a plurality of managing policies one managing policy as a cache policy based on a command received from an external device, and managing the plurality of cache lines based on the changed cache policy.

According to another aspect of the inventive concept, there is provided an operating method of a memory device, the operating method including managing a plurality of cache lines based on a pre-set cache policy; receiving a cache policy setting command from a memory controller external to the memory device; changing the pre-set cache policy by selecting from a plurality of managing policies a managing policy as a new cache policy for operating the memory device when a cache policy based on the received cache policy setting command is different from the pre-set cache policy; and managing the plurality of cache lines based on the new cache policy.

### BRIEF DESCRIPTION OF THE DRAWINGS

Embodiments of the inventive concept will be more clearly understood from the following detailed description taken in conjunction with the accompanying drawings in which:

FIG. 1 is a schematic block diagram of an electronic system according to an exemplary embodiment;

FIG. 2 is a block diagram of a memory system according to an exemplary embodiment;

FIG. 3 is a block diagram of a memory device according to an exemplary embodiment;

FIG. 4A is a view for describing data mapping of cache memory and main memory of FIG. 1;

FIG. 4B is a view of an example of an address structure for accessing the cache memory of FIG. 1;

FIGS. 5A and 5B are block diagrams of cache policy setting circuits according to exemplary embodiments;

FIG. 6 is a block diagram of an embodiment of a monitor circuit of FIG. 5B;

FIGS. 7A and 7B are views for describing operations of a memory device according to an exemplary embodiment;

FIGS. 8 through 11 are flowcharts of operations of a memory device according to an exemplary embodiment;

FIG. 12 is a flowchart of an operation of a memory system according to an exemplary embodiment;

FIGS. 13 and 14 are circuit diagrams of a memory device according to exemplary embodiments;

FIG. 15 is a view of a memory module according to an exemplary embodiment;

FIGS. 16 and 17 are flowcharts of an operation of a memory module according to an exemplary embodiment;

FIG. 18 is a view of a memory module according to an exemplary embodiment;

FIG. 19 is a view of a memory module according to an exemplary embodiment;

FIGS. 20 through 22 are block diagrams of a computing system according to exemplary embodiments; and

FIG. 23 is a block diagram of a mobile system according to an exemplary embodiment.

### DETAILED DESCRIPTION OF THE EMBODIMENTS

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

As is traditional in the field of the inventive concepts, embodiments are described, and illustrated in the drawings, in terms of functional blocks, units and /or modules. Those skilled in the art will appreciate that these blocks, units and /or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and /or modules being implemented by microprocessors or similar, they may be programmed using software (e.g., microcode) to perform various functions discussed herein and may optionally be driven by firmware and /or software. Alternatively, each block, unit and /or module may be implemented by dedicated hardware, or as a combination of dedicated hardware to perform some functions and a processor (e.g., one or more programmed microprocessors and associated circuitry) to perform other functions. Also, each block, unit and /or module of the embodiments may be physically separated into two or more interacting and discrete blocks, units and /or modules without departing from the scope of the inventive concepts. Further, the blocks, units and /or modules of the embodiments may be physically combined into more complex blocks, units and /or modules without departing from the scope of the inventive concepts.

Hereinafter, various embodiments of the present inventive concept will be described with reference to the accompanying drawings.

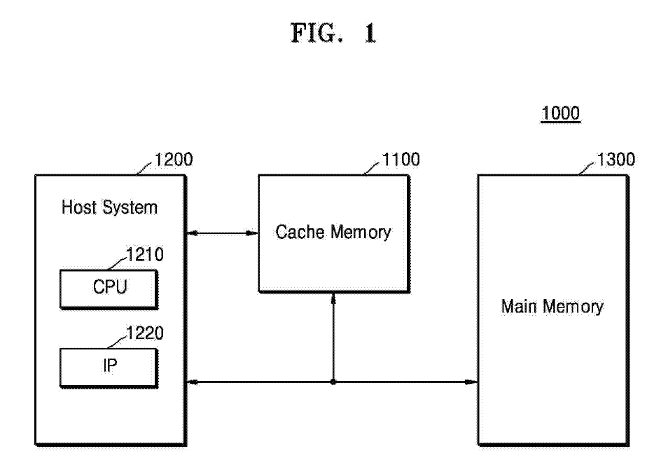

FIG. 1 is a schematic block diagram of an electronic system 1000 according to an exemplary embodiment.

Referring to FIG. 1, the electronic system 1000 may be realized as at least one of smart phones, tablet personal computers (PCs), mobile phones, video telephones, electronic-book readers, desktop PCs, laptop PCs, netbook computers, personal digital assistants (PDAs), portable multimedia players (PMPs), MPEG audio layer 3 (MP3) players, cameras, wearable devices, servers, vehicle electronic devices, marine electronic equipment (for example, marine navigation devices, gyrocompasses, etc.), avionics, security devices, industrial or household robots, automatic teller's machines (ATMs), electronic medical devices, household appliances, smart furniture, and parts of buildings/constructions.

The electronic system 1000 may include a host system 1200, cache memory 1100, and main memory 1300.

The host system 1200 may control general operations of the electronic system 1000 and perform logical operations. For example, the host system 1200 may be formed as a system-on-chip (SoC). The host system 1200 may include a central processing unit (CPU) 1210 and intellectual properties (hereinafter IP) 1220.

The CPU 1210 may process or execute programs and /or data stored in the main memory 1300. According to an embodiment, the CPU 1210 may be realized as a multi-core processor. According to an embodiment, the CPU 1210 may include a cache (for example, an L1 cache, not shown) located on the same chip.

The IP 1220 refers to a circuit, logic, or a combination thereof, which may be integrated in the electronic system 1000. The circuit or logic may store a computing code.

The IP 1220 may include, for example, a graphics processing unit (GPU), a multi-format codec (MFC), a video module (for example, a camera interface, a joint photographic experts group (JPEG) processor, a video processor, a mixer, etc.), an audio system, a driver, a display driver, a volatile memory device, a non-volatile memory device, a memory controller, cache memory, a serial port, a system timer, a watch dog timer, an analog-to-digital converter, or the like.

According to an embodiment, the IP 1220 may include cache memory inside thereof. FIG. 1 illustrates that the host system 1200 includes one IP 1220. However, the present inventive concept is not limited thereto, and the host system 1200 may include a plurality of IPs.

The main memory 1300 may store or read data requested by the host system 1200. For example, the main memory 1300 may store commands and data which may be executed by the CPU 1210. Also, the main memory 1300 may store or read data requested by the IP 1220.

The main memory 1300 may be realized as a volatile memory device or a non-volatile memory device. The volatile memory device may be realized as dynamic random access memory (DRAM), static random access memory (SRAM), thyristor RAM (T-RAM), zero capacitor RAM (Z-RAM), or twin transistor RAM (TTRAM).

The non-volatile memory device may be realized as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano-floating gate memory (NFGM), holographic memory, a molecular electronics memory device, or insulator resistance change memory.

The cache memory 1100 is a memory for temporarily storing a portion of data stored or to be stored in the main memory 1300. The cache memory 1100 is a memory for quickly accessing data used in the main memory 1300 or a disk (not shown) by using a temporal or spatial based cache policy when a program is executed. A temporal-based cache policy may define the freshness of cache entries using the time the resource/data was retrieved. A spatial-based cache policy may define the freshness of cache entries based on where the requested resource/data can be taken from.

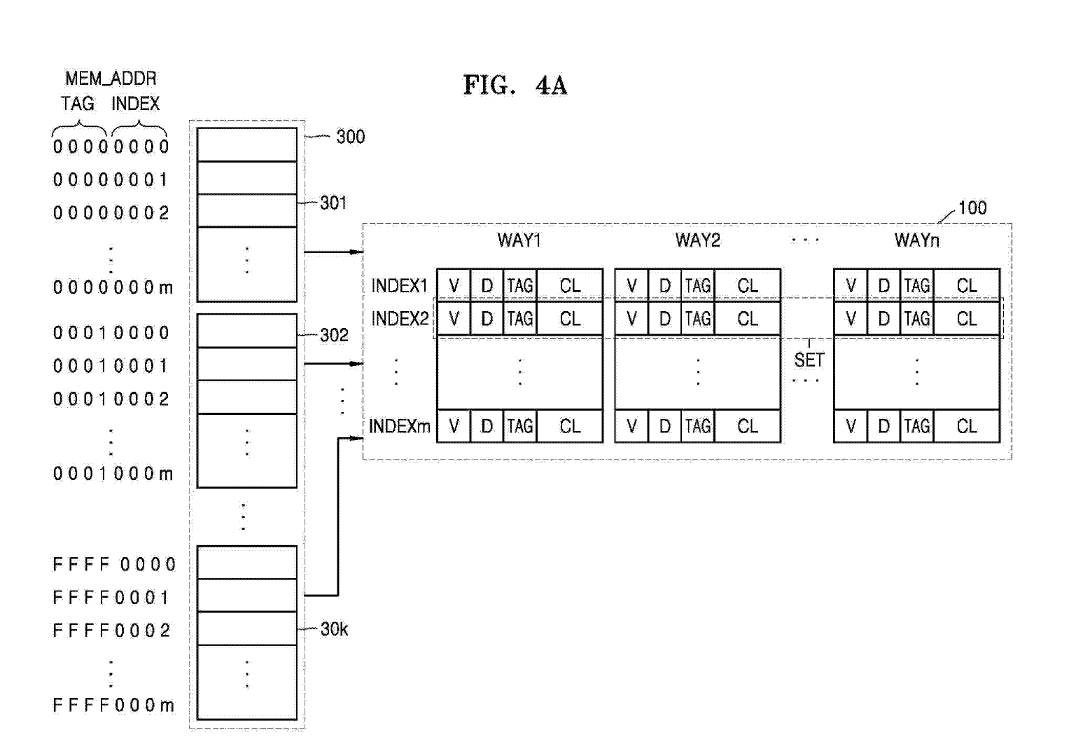

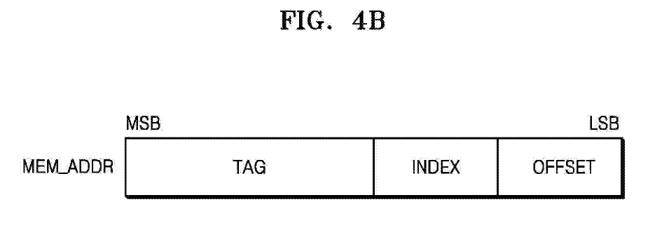

The cache memory 1100 may be arranged between the host system 1200 and the main memory 1300. A portion of the data stored in the main memory 1300 may be copied to the cache memory 1100 and a tag indicating data stored in which location of the main memory 1300 is copied to the cache memory 1100 may further be stored in the cache memory 1100. A data unit corresponding to one tag, that is, a data block transmitted between the cache memory 1100 and the main memory 1300, is referred to as a cache line. Detailed aspects thereof will be described later with reference to FIGS. 4A and 4B.

Based on a tag comparison operation, whether data, an access to which is requested by the host system 1200, exists in the cache memory 1100 is determined. When the data, an access to which is requested, exists (i.e., a cache hit) in the cache memory 1100, the data of the cache memory 1100 may be provided to the host system 1200. When the data, an access to which is requested, does not exist (i.e., a cache miss) in the cache memory 1100, data having a certain size including the requested data may be read from the main memory 1300 and copied to the cache memory 1100, and the data requested by the host system 1200 may be read from the copied data and provided to the host system 1200.

In this case of a cache miss, a victim cache line (or replacement cache line) may be selected from among cache lines stored in the cache memory 1100, based on a cache policy of the cache memory 1100, and the data read from the main memory 1300 may be copied to a cell area (referred to as a way) in which the victim cache line is stored. The cache memory 1100 may dynamically change the cache policy based on a use environment, such as a request pattern from the host system 1200. For example, the cache policy may include a cache line replacement policy. While the cache memory 1100 uses a least recently used (LRU)-based replacement policy, the cache memory 1100 may change the cache line replacement policy from the least recently used (LRU)-based replacement policy to a clean cache line first-based replacement policy, if there are many write requests from the host system 1200. Here, the clean cache line refers to a cache line storing data having same values from data stored in the main memory 1300. For example, when the cache memory 1100 uses a least recently used (LRU)-based replacement policy, the cache memory 1100 may select preferentially the least recently used cache line first for the victim cache line. When the cache memory 1100 uses a clean cache line first-based replacement policy, the cache memory 1100 select preferentially a clean cache line for the victim cache line. In some embodiments, the cache line replacement policy of the cache memory 1100 may be changed from the least recently used (LRU)-based replacement policy to the clean cache line first-based replacement policy if there are many write requests from the host system 1200, and then, the cache memory 1100 will select preferentially a clean cache line for the victim cache line.

The cache memory 1100 may be realized as a volatile memory or a nonvolatile memory. Hereinafter, an example in which the cache memory 1100 is realized as DRAM will be described. However, the present inventive concept is not limited thereto, and various memory devices, such as a memory device capable of accessing a memory cell array in a page unit and a memory device capable of accessing a memory cell array in a column address and a row address unit, may be applied.

When a nonvolatile memory, such as flash memory or PRAM, is used as the main memory 1300, the number of writing operations is limited, and thus, life span thereof may be limited. Thus, when the cache memory 1100 applies a read latency-based cache policy, a dirty cache line may be frequently replaced. Here, the dirty cache line refers to a cache line storing data having different values from data stored in the main memory 1300. Thus, the life span of the main memory 1300 may be radically reduced. Also, when the dirty cache line is maintained for a long time in order to reduce the number of writing operations of the main memory 1300, a cache re-using rate may be decreased, and the cache memory 1100 itself may fail to function. Therefore, when a single cache policy is used, the performance of the cache memory 1100 may not be sufficiently exhibited. However, as described above, the cache memory 1100 according to the present embodiment may dynamically change the cache policy according to the use environment, and thus, the performance of the electronic system 1000 and the reliability of the main memory 1300 may be improved.

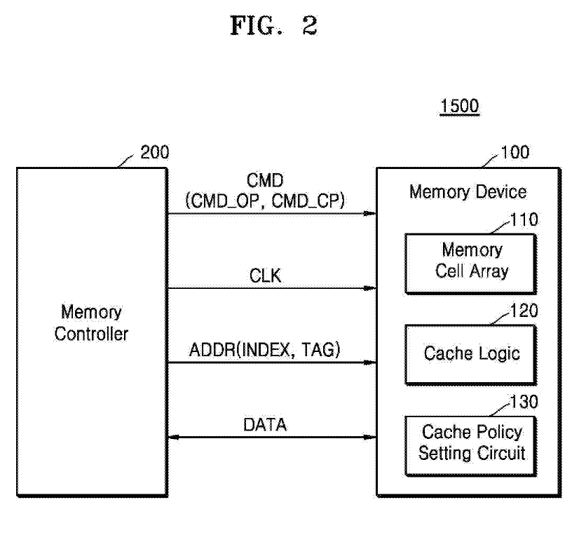

FIG. 2 is a block diagram of a memory system 1500 according to an exemplary embodiment.

Referring to FIG. 2, the memory system 1500 may include a memory device 100 and a memory controller 200. The memory device 100 may operate as cache memory. The memory device 100 may be applied as the cache memory 1100 of FIG. 1, and the disclosure of the cache memory 1100 described with reference to FIG. 1 may be applied to the memory device 100. It is assumed that the memory device 100 includes a DRAM device.

In some exemplary embodiments, the memory device 100 and /or the memory controller 200 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The memory controller 200 may transmit a command signal CMD, a clock CLK, and an address signal ADDR to the memory device 100 and may exchange read/write data DATA with the memory device 100. The memory controller 200 may generate the command signal CMD and the address signal ADDR based on an access request from an external device, for example, the host system (1200 of FIG. 1).

The command signal CMD may indicate an operation command CMD_OP controlling a normal operation of the memory device 100, for example a write or read operation. Also, the command signal CMD may indicate a cache policy setting command CMD_CP controlling changing of a cache policy of the memory device 100. According to an embodiment, the cache policy setting command CMD_CP may be received by the memory device 100 via an input and output pin different from an input and output pin via which the operation command CMD_OP is received, from among input and output pins of the memory device 100. According to another embodiment, the input and output pin via which the cache policy setting command CMD_CP is received may be the same as the input and output pins via which the operation command CMD_OP is received.

The address signal ADDR may include an index INDEX and a tag TAG. The address signal ADDR may further include an offset. The address signal ADDR is a signal for determining whether data corresponding to an address (for example, an address of the main memory (1300 of FIG. 1) requested from an external device is stored in the memory device 100, and may include a portion or all of bits of the requested address.

The memory device 100 may include a memory cell array 110, cache logic 120, and a cache policy setting circuit 130.

The memory cell array 110 may include a plurality of DRAM cells. The memory cell array 110 may store a plurality of cache lines and a plurality of tags corresponding to the plurality of cache lines.

The cache policy setting circuit 130 may set a cache policy of the memory device 100. For example, the cache policy may include one of a replacement policy, an assignment policy, and a write policy. According to an exemplary embodiment, the cache policy setting circuit 130 may select at least one of a plurality of managing policies and may set the cache policy based on the selected managing policy. According to an exemplary embodiment, the cache policy setting circuit 130 may change the cache policy in response to a received cache policy setting command CMD_CP. According to an exemplary embodiment, the cache policy setting circuit 130 may monitor an access command, for example, an operation command CMD_OP, and change the cache policy based on a result of the monitoring.

The cache logic 120 may determine a cache hit or a cache miss. Also, the cache logic 120 may control a cache operation of the memory device 100, based on the set cache policy. The cache logic 120 may manage the plurality of cache lines or the plurality of tags stored in the memory cell array 110. For example, when a cache miss occurs, the cache logic 120 may select a victim cache line based on the cache policy and replace the cache line.

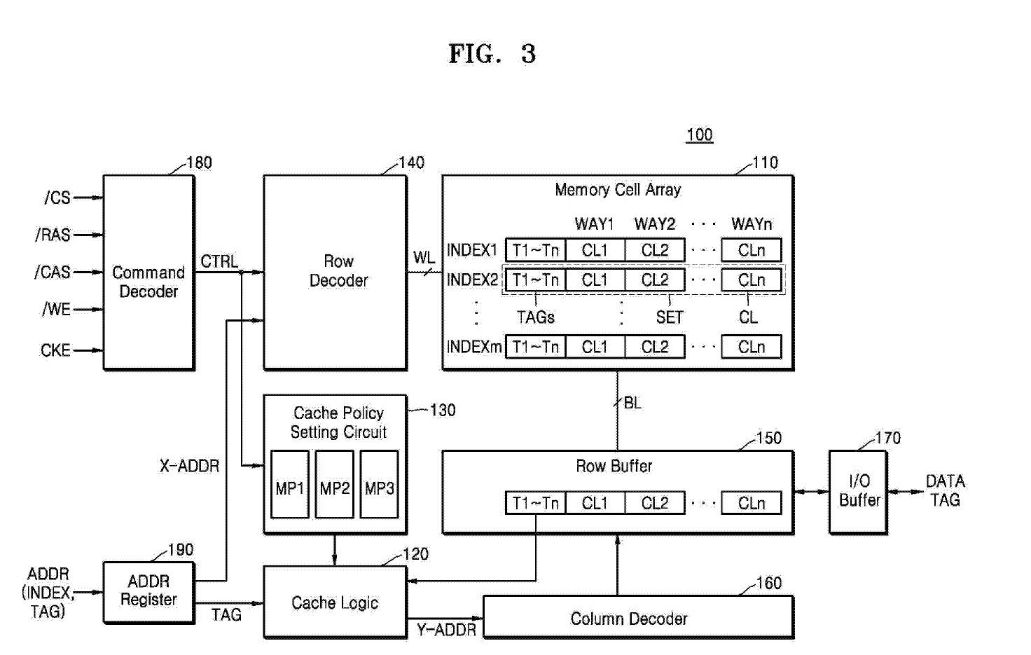

FIG. 3 is a block diagram of the memory device 100 according to an exemplary embodiment.

Referring to FIG. 3, the memory device 100 may include the memory cell array 110, the cache logic 120, the cache policy setting circuit 130, a row decoder 140, a row buffer 150, a column decoder 160, an input and output buffer 170, a command decoder 180, and an address register 190.

The memory cell array 110 may store a plurality of cache lines CL and a plurality of tags TAGs corresponding to the plurality of cache lines CL. The tags may indicate in which locations of the main memory the cache lines corresponding to the tags are.

The memory cell array 110 may include a plurality of memory cells arranged in a matrix including a plurality of rows and a plurality of columns. The memory cell array 110 may be connected to the row decoder 140 and the row buffer 150 via a word line WL and a bit line BL.

Each of the rows in the memory cell array 110 may be distinguished by index numbers INDEX1 to INDEXm. For example, one row may correspond to one index number. Each row may include a plurality of ways (cell areas) WAY1 to WAYn. (Each of The plurality of rows may store a plurality of cache lines CL1 to CLn corresponding to the plurality of ways WAY1 to WAYn and a plurality of tags T1 to Tn corresponding to the plurality of cache lines CL1 to CLn. For convenience of explanation, the cache line CL and the tag corresponding to each of the plurality of ways WAY1 to WAYn in one row will be referred to by the same number. It is illustrated in FIG. 3 that the plurality of tags TAGs and the plurality of cache lines CL are separately stored. However, the present inventive concept is not limited thereto, and the plurality of tags TAGs and the plurality of cache lines CL may be alternately stored in one row.

The plurality of rows may further include state information (for example, dirty or clean, or valid or non-valid) with respect to each of the plurality of cache lines CL1 to CLn. The plurality of cache lines CL, the plurality of tags TAGs, and the state information stored in each of the plurality of rows may form one set.

The command decoder 180 may perform a decoding operation by receiving command signals received from the memory controller (200 of FIG. 2), for example, a chip select signal /CS, row address strobe /RAS, column address strobe /CAS, and write enable /WE and clock enable CKE signals. The command decoder 180 may generate an internal control signal CTRL according to a command identified through the decoding operation. The command decoder 180 may provide the control signal CTRL to the row decoder 140 and the cache policy setting circuit 130, and may also provide the control signal CTRL to other components of the memory device 100.

The cache policy setting circuit 130 may set a cache policy of the memory device 100. The cache policy setting circuit 130 may include a plurality of managing policies MP1, MP2, and MP3, and may set the cache policy by selecting at least one of the plurality of managing policies MP1, MP2, and MP3. FIG. 3 illustrates three managing policies. However, the present inventive concept is not limited thereto, and various numbers and types of managing policies may be included. For example, the plurality of managing policies MP1 to MP3 may include a replacement policy, an assignment policy, or a write policy. The plurality of managing policies MP1 to MP3 may be realized as an algorithm, a circuit, or a circuit for executing an algorithm.

The cache policy setting circuit 130 may dynamically change the cache policy based on the received control signal CTRL.

The address signal ADDR received from the memory controller 200 may be stored in the address register 190. The address register 190 may provide an index INDEX of the address signal ADDR to the row decoder 140 as a row address X-ADDR and may provide a tag TAG to the cache logic 120.

The row decoder 140 may select a word line WL based on the control signal CTRL and the row address X-ADDR. Accordingly, a row having an index corresponding to the row address X-ADDR may be activated. Data stored in the activated row, that is, the plurality of cache lines CL and the plurality of tags TAGs may be loaded to the row buffer 150 via the bit line BL. The row buffer 150 may be realized as a sensing amplification circuit sensing data of a memory cell connected to the bit line BL.

The cache logic 120 determines whether a cache hit occurs by comparing the tag TAG provided from the address register 190, that is, the received tag, with the plurality of tags T1 to Tn loaded to the row buffer 150. The cache logic 120 may determine that a cache hit occurs, when the received tag TAG is matched with one of the plurality of tags T1 to Tn, and may determine that a cache miss occurs, when the received tag TAG is not matched with the plurality of tags T1 to Tn.

When the cache hit occurs, the cache logic 120 may generate a column address Y-ADDR based on information (for example, way information, etc.) indicating a cache line corresponding to the matched tag, from among the plurality of cache lines CL1 to CLn loaded to the row buffer 150. When the cache miss occurs, the cache logic 120 may select a replacement cache line based on the cache policy set by the cache policy setting circuit 130 and generate the column address Y-ADDR based on information indicating the cache line.

The cache logic 120 may provide the column address Y-ADDR to the column decoder 160. The column decoder 160 may select data of a cache line (or a portion of the data of the cache line) corresponding to the column address Y-ADDR, from among data loaded to the row buffer 150. The row buffer 150 may output the selected data DATA and a tag TAG corresponding to the selected data DATA to the outside via the input and output buffer 170. The data DATA and the tag TAG may be transmitted to the memory controller (200 of FIG. 2) or the main memory (1300 of FIG. 1).

FIG. 4A is a view for describing data mapping of a cache memory and a main memory according to an exemplary embodiment. FIG. 4A illustrates n-way set associative mapping, as an example of the mapping operation.

The main memory 300 is divided into a plurality of blocks 301 to 30k having certain sizes, and a tag value is assigned to correspond to each of the divided blocks 301 to 30k. For example, a tag value of the first block 301 may be 0000, and a tag value of the second block may be 0001. Each of the plurality of blocks 301 to 30k may be divided into a plurality of areas, and an index value may be assigned to correspond to each of the plurality of areas.

The cache memory 100 may include a plurality of ways WAY1 to WAYn. Sizes of the ways WAY1 to WAYn may be the same as sizes of the blocks 301 to 30k of the main memory 300.

When data of the main memory 300 is copied to the cache memory 100, a cache line CL indicating data of a certain size and a tag value of the cache line CL may be written to the cache memory 100. Also, state information V and D with respect to the cache line may be written to the cache memory 100. The cache line CL, the tag TAG, and the state information V and D having the same index value in the plurality of ways WAY1 to WAYn may form one set SET.

Thereafter, when the data stored in the cache memory 100 is read, any one of a plurality of sets SET may be selected according to index information indicating a set SET, and one cache line may be selected from among the plurality of cache lines CL included in one set, based on an operation of comparing tag values.

FIG. 4B is a view of an example of an address structure for accessing the cache memory 1100 of FIG. 1.

Referring to FIG. 4B, a memory address MEM_ADDR may include a tag TAG field, an index INDEX field, and an offset OFFSET field. Any one of the plurality of sets may be selected by using a value of the index INDEX field, and any one of the plurality of cache lines may be selected by using a value of the tag TAG field. Also, an access to any one cache line in a byte unit may be possible by using a value of the offset OFFSET field.

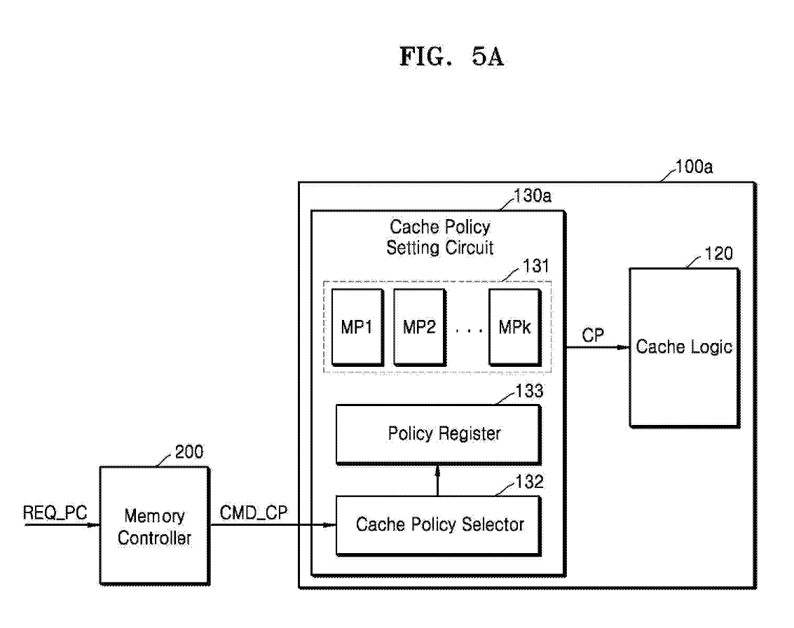

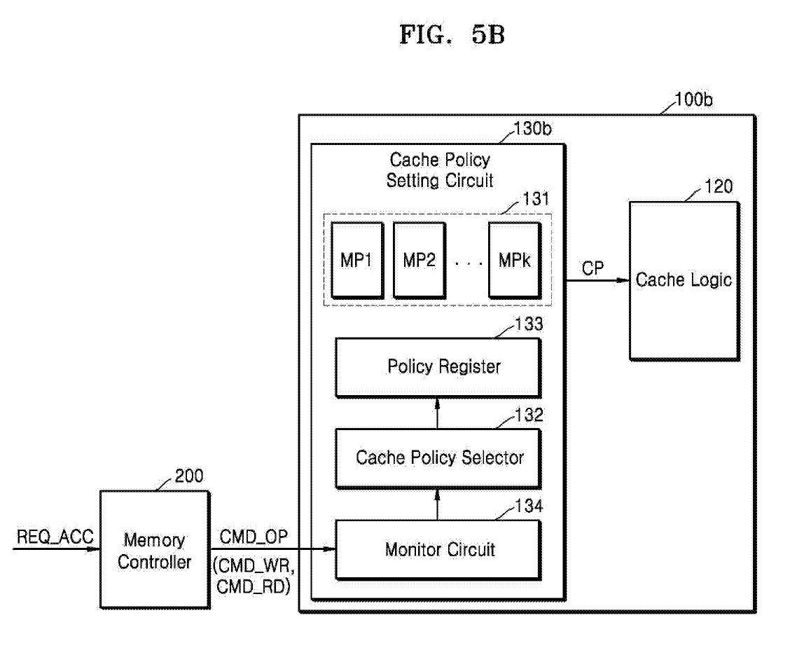

FIGS. 5A and 5B are block diagrams of cache policy setting circuits 130a and 130b according to example embodiments. For convenience of explanation, FIGS. 5A and 5B illustrate the memory controller 200 and the cache logic 120 together.

Referring to FIG. 5A, when there is a cache policy change request REQ_PC from an external device, for example, a host system, the memory controller 200 may generate a cache policy setting command CMD_CP corresponding to the request, and provide the generated cache policy setting command CMD_CP to a memory device 100a. According to an embodiment, the cache policy change request REQ_PC may include a signal requesting a change from a previously set cache policy of the memory device 100a to another cache policy. According to an embodiment, the cache policy change request REQ_PC may include a signal indicating a characteristic of an access request from the host system (for example, whether the access request is a request centered on writing or a request centered on reading, etc.). According to another embodiment, the memory controller 200 may analyze the access request (a write or read request) from the host system and generate the cache policy setting command CMD_CP based on the characteristic of the access request.

The cache policy setting circuit 130a may include a plurality of managing policies 131, a policy register 133, and a cache policy selector 132.

The plurality of managing policies 131 may be realized as an algorithm, a circuit, or a circuit for executing an algorithm. The plurality of managing policies 131 may include a replacement policy, an assignment policy, a write policy, etc., related to a cache operation.

The cache policy selector 132 may select at least one of the plurality of managing policies 131. When the cache policy setting command CMD_CP is received from the memory controller 200, the cache policy selector 132 may select a managing policy in response to the cache policy setting command CMD_CP. The cache policy selector 132 may provide a value indicating the selected managing policy to the policy register 133.

The policy register 133 may store information about the selected managing policy. By doing so, the cache policy setting circuit 130a may set a cache policy based on at least one of the plurality of managing policies 131, based on the value stored in the policy register 133.

The cache logic 120 may control the cache operation of the memory device 100a based on the cache policy CP.

Referring to FIG. 5B, the cache policy setting circuit 130b may include the plurality of managing policies 131, the policy register 133, the cache policy selector 132, and a monitor circuit 134. Compared with the cache policy setting circuit 130a of FIG. 5A, the cache policy setting circuit 130b of FIG. 5B may further include the monitor circuit 134. The cache policy setting circuit 130b of FIG. 5B may perform the operation of the cache policy setting circuit 130a of FIG. 5A, and may further perform an operation based on monitoring of the monitor circuit 134.

When the memory controller 200 receives an access request REQ_ACC from an external device, for example, a host system, the memory controller 200 may generate an operation command CMD_OP including a write or read command and provide the operation command CMD_OP to a memory device 100b. The operation command CMD_OP may include, for example, a write command CMD_WR or a read command CMD_RD.

The monitor circuit 134 may analyze an operation pattern requested for the memory device 100b. The monitor circuit 134 may monitor the received operation command CMD_OP or data input and output. The monitor circuit 134 may analyze the operation pattern or workload requested for the memory device 100b, based on a result of the monitoring. The monitor circuit 134 may provide a result of the analysis to the cache policy selector 132.

The cache policy selector 132 may determine whether to change the previously set cache policy, based on the result of the analysis. When the cache policy selector 132 determines that it is needed to change the cache policy, the cache policy selector 132 may select at least one of the plurality of managing policies 131 based on the result of the analysis.

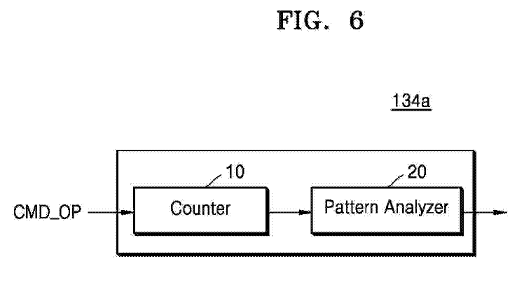

FIG. 6 is a block diagram of an exemplary embodiment of the monitor circuit 134 of FIG. 5B.

Referring to FIG. 6, a monitor circuit 134a may include a counter 10 and a pattern analyzer 20. The counter 10 may count received operation commands CMD_OP. In detail, the operation commands CMD_OP may include write commands CMD_WR and read commands CMD_RD, and the counter 10 may count each of the write commands CMD_WR and the read commands CMD_RD.

According to an embodiment, the counter 10 may count each of the write commands CMD_WR and the read commands CMD_RD received in a pre-set period. According to another embodiment, the counter 10 may sequentially count only predetermined numbers of received access requests, that is, the write commands CMD_WR and the read commands CMD_RD, and may separate the number of write commands CMD_WR and the number of read commands CMD_RD.

The pattern analyzer 20 may analyze the operation pattern based on a result of counting the write commands CMD_WR and the read commands CMD_RD. The pattern analyzer 20 may analyze that write requests are frequent, when the counted number of write commands CMD_WR is equal to or higher than a pre-set threshold value, or a ratio of write requests to total access requests, that is, a ratio of the counted write commands CMD_WR to the counted write commands CMD_WR and read commands CMD_RD, is equal to or higher than a threshold value.

When a cache miss occurs based on a result of the analysis, the cache policy setting circuit 130b may select a managing policy for selecting preferentially a clean cache line from among a plurality of cache lines, as a victim cache line, and based on the selected managing policy, the cache policy may be changed.

As shown above, the embodiment of the monitor circuit 134 of FIG. 5B has been described with reference to FIG. 6. However, this is only an embodiment, and structures and operations of the monitor circuit 134 may be changed in various ways within the technical scope of the present inventive concept.

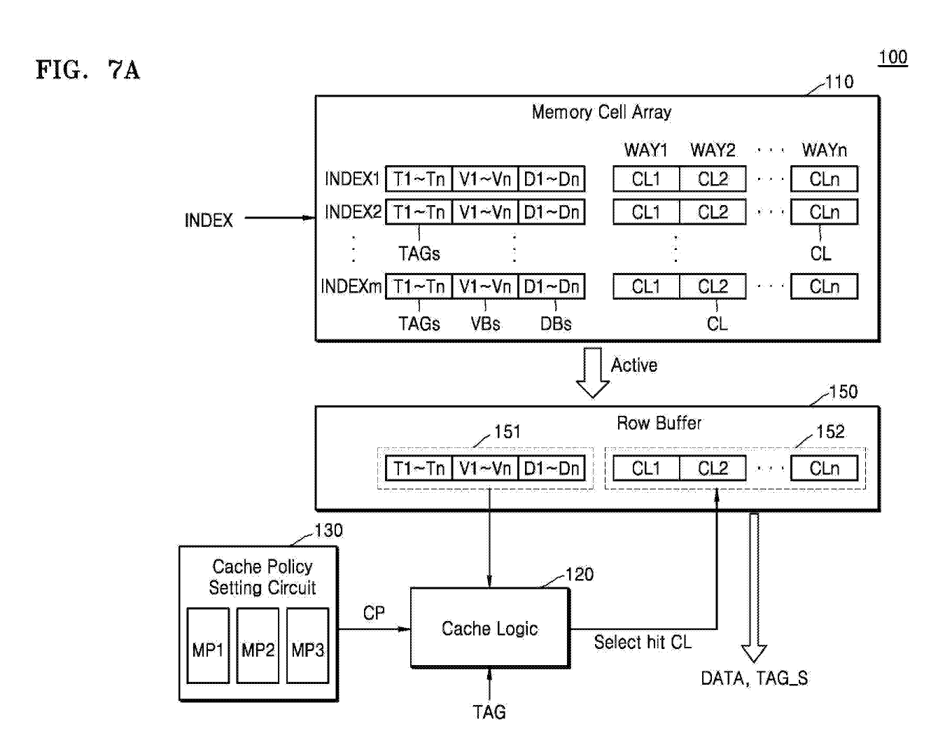

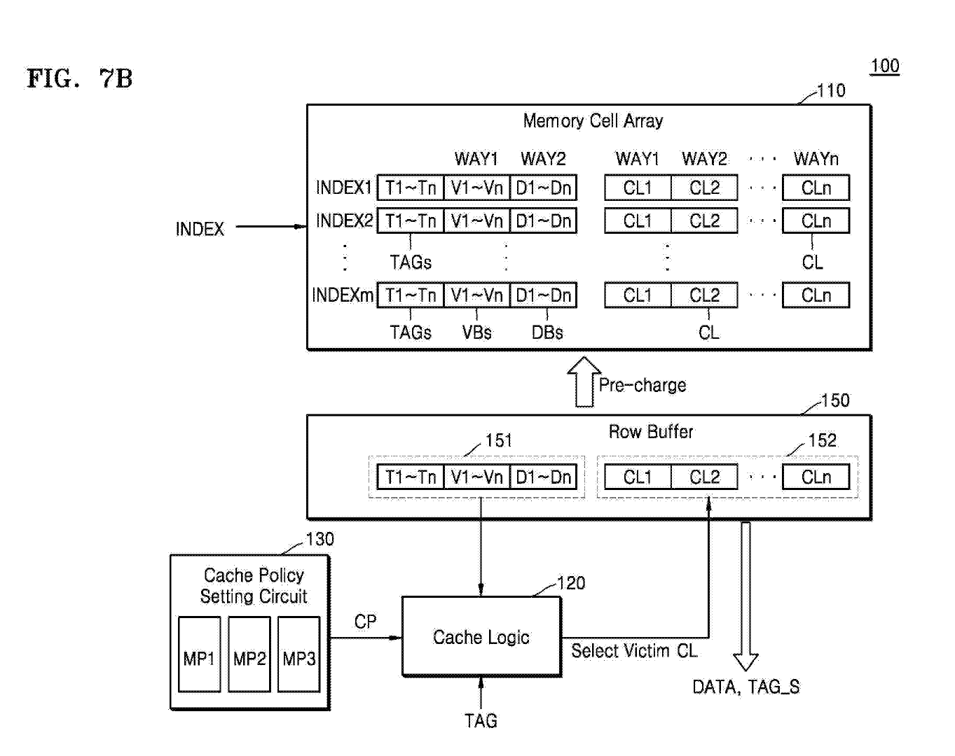

FIGS. 7A and 7B are views for describing operations of the memory device 100, according to an exemplary embodiment. FIG. 7A is the view for describing the operation of determining a cache hit via the memory device 100, and FIG. 7B is the view for describing the operation of replacing a cache line when a cache miss occurs.

Referring to FIG. 7A, the memory device 100 may active a row corresponding to an index INDEX based on an active command and the index INDEX that are received and load pieces of data stored in the row corresponding to the index INDEX to the row buffer 150. The pieces of loaded data may include cache lines 152 of the selected row and metadata 151 corresponding to the cache lines 152. The metadata 151 may include tags TAGs corresponding to the loaded cache lines 152 and pieces of state information VBs and DBs.

The cache logic 120 may determine a cache hit by comparing the tags T1 to Tn and valid information V1 to Vn of the metadata 151 with a received tag TAG. The cache logic 120 may select a cache line corresponding to a tag TAG_S matched with the received tag TAG. At least a portion of data DATA of the selected cache line and the matched tag TAG_S may be output to the outside of the memory device 100.

Referring to FIG. 7B, when a cache miss occurs, the cache logic 120 may replace the cache line based on the cache policy CP set by the cache policy setting circuit 130. The cache logic 120 may select a victim cache line based on a replacement policy from among the cache policy CP. The row buffer 150 may replace the cache line. The row buffer 150 may output data DATA of the selected victim cache line and a tag TAG_S corresponding to the victim cache line to the outside of the memory device 100, and receive data DATA and a tag TAG_S of a new cache line. Thereafter, the memory cell array 110 may be pre-charged. As the cache lines and the metadata loaded to the row buffer 150 are stored in the row corresponding to the index INDEX, data stored in the index INDEX may be updated.

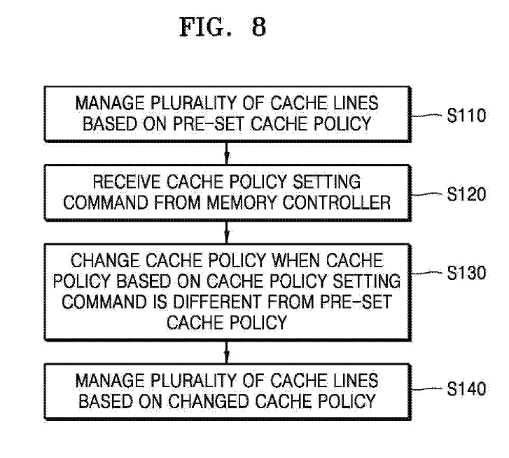

FIGS. 8 through 11 are flowcharts of operations of the memory device 100, according to an exemplary embodiment.

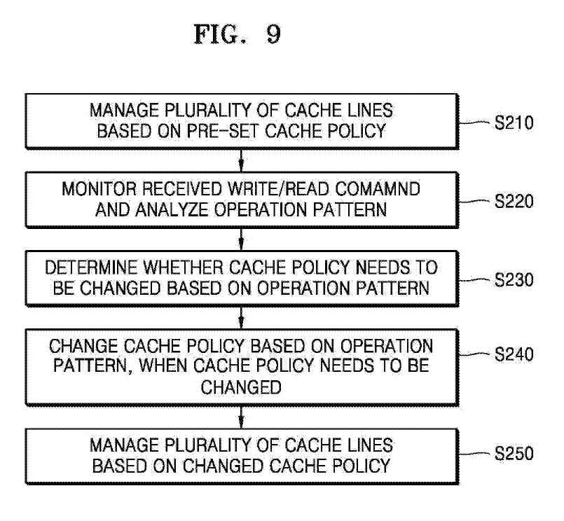

In detail, FIGS. 8 and 9 are the flowcharts of an operation of changing a cache policy via the memory device 100, according to embodiments.

Referring to FIG. 8, the memory device (100 of FIG. 2) may manage a plurality of cache lines based on a pre-set cache policy, in operation S110. For example, a default value may be set in the policy register (133 of FIG. 5A), a managing policy based on the default value may be selected from among a plurality of managing policies, and a cache policy may be set based on the selected managing policy.

A cache policy setting command may be received from the memory controller (200 of FIG. 2) in operation S120. The memory device 100 may change the cache policy when a cache policy based on the cache policy setting command is different from the pre-set cache policy, in operation S130. For example, the cache policy selector (132 of FIG. 5A) may select at least one of the plurality of managing policies, which corresponds to the cache policy setting command, and provide a value indicating information with respect to the selected managing policies to the policy register 133.

The memory device 100 may manage the plurality of cache lines based on the changed cache policy in operation S140.

Referring to FIG. 9, the memory device 100 may manage a plurality of cache lines based on a pre-set cache policy, in operation S210. The memory device 100 may monitor received write and read commands and analyze an operation pattern in operation S220. According to an embodiment, the memory device 100 may periodically analyze the operation pattern. According to an embodiment, the memory device 100 may analyze the operation pattern during a certain time period (e.g., a pre-set time period) after an operation command is received from the memory controller 200.

The memory device 100 may determine whether the cache policy needs to be changed, based on the operation pattern, in operation S230. The memory device 100 may determine the cache policy for improving cache performance, based on the operation pattern, and may determine whether the pre-set cache policy corresponds to the cache policy determined based on the operation pattern.

When the pre-set cache policy does not correspond to the cache policy determined based on the operation pattern, the memory device 100 may determine that the cache policy needs to be changed, and change the cache policy, in operation S240. Then, the memory device 100 may manage the plurality of cache lines based on the changed cache policy, in operation S250.

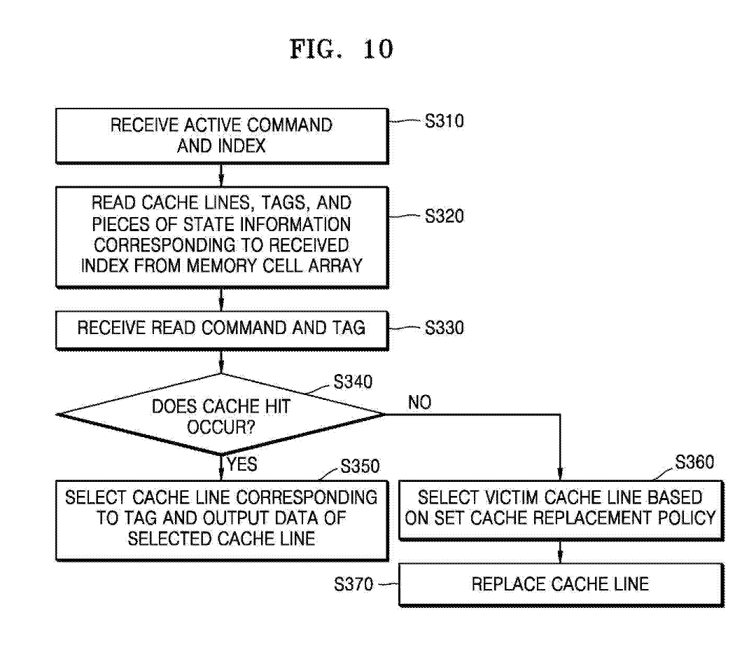

FIG. 10 is the flowchart of an operation of the memory device 100, according to an exemplary embodiment. In detail, FIG. 10 shows the operation of determining a cache hit and replacing the cache line, via the memory device 100, when the memory device 100 receives a read command.

Referring to FIG. 10, the memory device 100 may receive an active command and an index from the memory controller (200 of FIG. 2) in operation S310.

The memory device 100 may read cache lines, tags, and state information corresponding to an index received from the memory cell array 110, in operation S320. For example, the read data may be loaded to the row buffer 150.

The memory device 100 may determine the cache hit in operation S340, when a read command and a tag are received from the memory controller (200 of FIG. 2) in operation S330. The memory device 100 may search for a tag that is matched by comparing tags loaded to the row buffer 150 with the received tag, and when a cache line corresponding to the matched tag is valid, may determine the cache hit. When there is no matched tag, or the cache line corresponding to the matched tag is non-valid, the memory device 100 may determine a cache miss.

When a cache hit occurs, the memory device 100 may select a cache line corresponding to the tag and output data of the selected cache line in operation S350. Also, the memory device 100 may output the matched tag.

When a cache miss occurs, the memory device 100 may replace the cache line in operation S370. The memory device 100 may select a victim cache line based on the set cache replacement policy in operation S360. When the victim cache line is in a dirty state, data of the victim cache line may be stored in the main memory. Then, the memory device 100 may read a cache line including data, an access to which is requested, and a tag corresponding to the cache line, from the main memory, and store the read cache line and tag in a way in which the victim cache line is stored.

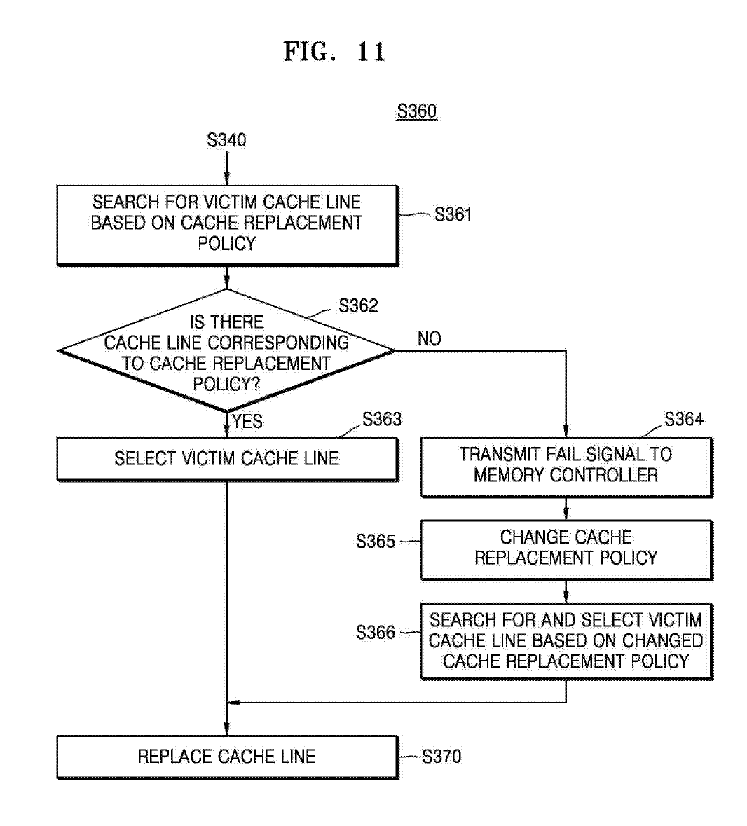

FIG. 11 is the flowchart of an operation method according to an exemplary embodiment. In detail, FIG. 11 illustrates an embodiment of the operation of selecting the victim cache line of FIG. 10 in more detail.

Referring to FIG. 11, when a cache miss occurs, the memory device 100 may search for the victim cache line based on a cache replacement policy in operation S361. The memory device 100 may search for a cache line to be selected as the victim cache line, from among the cache lines loaded to the row buffer 150. For example, when the cache replacement policy is set based on a managing policy for preferentially selecting a clean cache line as a replacement cache line, the clean cache line may be searched for from among the cache lines loaded to the row buffer 150.

The memory device 100 may determine whether there is a cache line corresponding to the cache replacement policy in operation S362. When there is the cache line corresponding to the cache replacement policy, the memory device 100 may select the cache line as the victim cache line in operation S363 and replace the cache line in operation S370.

When there is no cache line corresponding to the cache replacement policy, the memory device 100 may transmit a fail signal indicating that the victim cache line is not found to the memory controller 200 in operation S364 and may change the cache replacement policy in operation S365. According to an embodiment, the memory device 100 may re-receive a cache policy setting command from the memory controller 200, and change the cache replacement policy based on the received cache policy setting command. According to an embodiment, the memory device 100 may change the cache replacement policy based on a managing policy set as default. Thereafter, the memory device 100 may re-search for the victim cache line based on the changed cache replacement policy and select a cache line corresponding to the cache replacement policy as the victim cache line in operation S366.

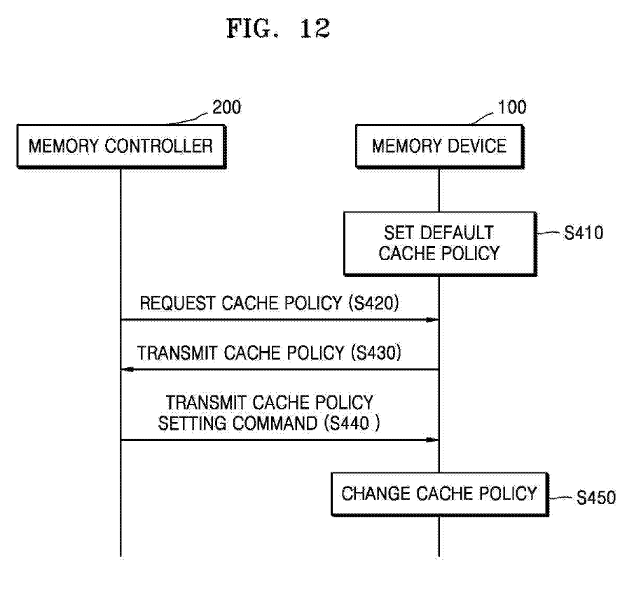

FIG. 12 is a flowchart of an operation of a memory system according to an exemplary embodiment.

Referring to FIG. 12, the memory device 100 may set a default cache policy in operation S410. For example, the default cache policy may be set based on a managing policy corresponding to a default value stored in the policy register (133 of FIG. 5A).

The memory controller 200 may request a set cache policy or information about the cache policy from the memory device 100 in operation S420. The memory device 100 may transmit the set cache policy or the information about the cache policy to the memory controller 200 in operation S430 in response to the request of the memory controller 200. When the cache policy is requested to be changed, the memory controller 200 may transmit a cache policy setting command to the memory device 100 in operation S440. For example, when a cache policy suitable for an operation requested from the host system is different from a cache-policy pre-set in the memory device 100, the memory controller 200 may transmit the cache policy setting command for setting the cache policy required by the host system.

The memory device 100 may change the cache policy based on the received cache policy setting command in operation S450. According to an embodiment, when an operation requested from the host system is temporary, the memory controller 200 may temporarily change the cache policy, and when the operation requested from the host system is completed, the memory controller 200 may change the cache policy to the default cache policy again.

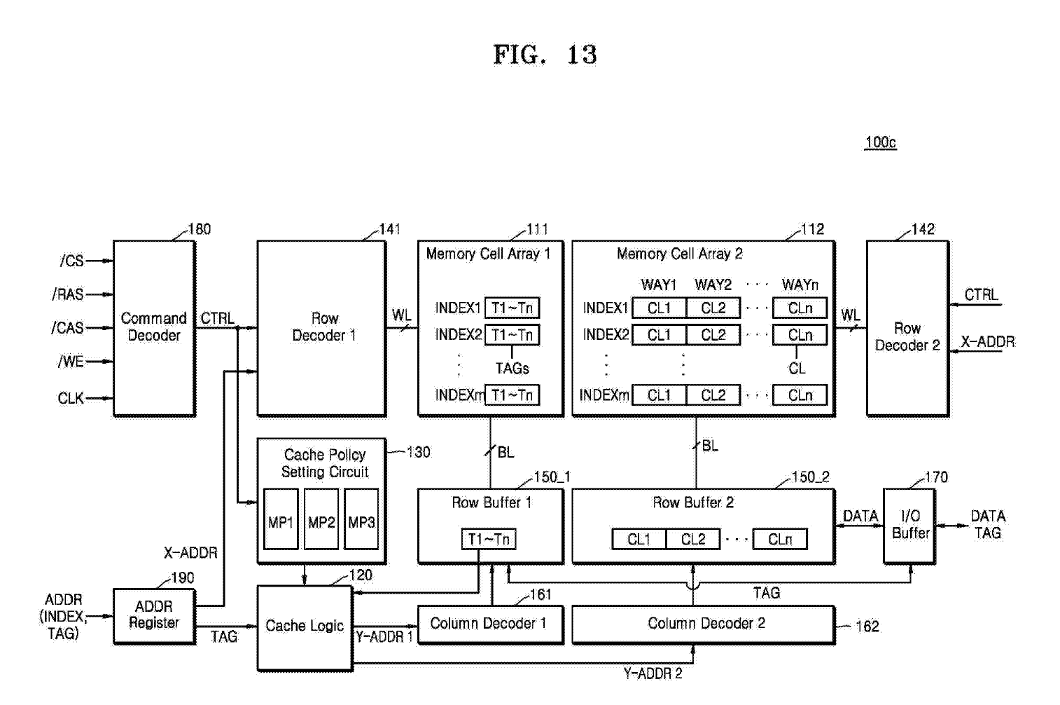

FIG. 13 is a block diagram of the memory device 100c according to exemplary embodiments.

FIG. 13 illustrates another embodiment of the memory device 100 of FIG. 3. Components having the same reference numerals in the memory device 100 of FIG. 3 and a memory device 100c of FIG. 13 have the same operations, and thus, their descriptions will be omitted.

Referring to FIG. 13, the memory device 100c may include a first memory cell array 111 and a second memory cell array 112. Also, the memory device 100c may include a first row decoder 141, a first row buffer 150_1 and a first column decoder 161 connected to the first memory cell array 111, and a second row decoder 142, a second row buffer 150_2, and a second column decoder 162 connected to the second memory cell array 112.

The second memory cell array 112 may store a plurality of cache lines and the first memory cell array 111 may store a plurality of tags TAGs corresponding to the plurality of cache lines, respectively. The plurality of cache lines CL1 to CLn and the plurality of tags T1 to Tn having the same index may be included in one set. The first row decoder 141 and the second row decoder 142 may receive the same row address X-ADDR and may operate in response to the received row address X-ADDR.

Each of the plurality of cache lines CL1 to CLn and the plurality of tags T1 to Tn having the same index may be loaded to the first row buffer 150_1 and the second row buffer 150_2. The cache logic 120 may compare the plurality of tags T1 to Tn loaded to the first row buffer 150_1 with a received tag TAG and provide a second column address Y-ADDR2 indicating a location of a cache line corresponding to the matched tag to the second row buffer 150_2 via the second column decoder 162. Also, the cache logic 120 may provide a first column address Y-ADDR1 indicating the location of the matched tag to the first row buffer 150_1 via the first column decoder 161. Each of the first row buffer 150_1 and the second row buffer 150_2 may output the tag TAG and data DATA. Also, the first row buffer 150_1 and the second row buffer 150_2 may load the received tag TAG and data DATA onto locations in the first row buffer 150_1 and the second row buffer 150_2, respectively, indicated by the first column address Y-ADDR1 and the second column address Y-ADDR2, respectively.

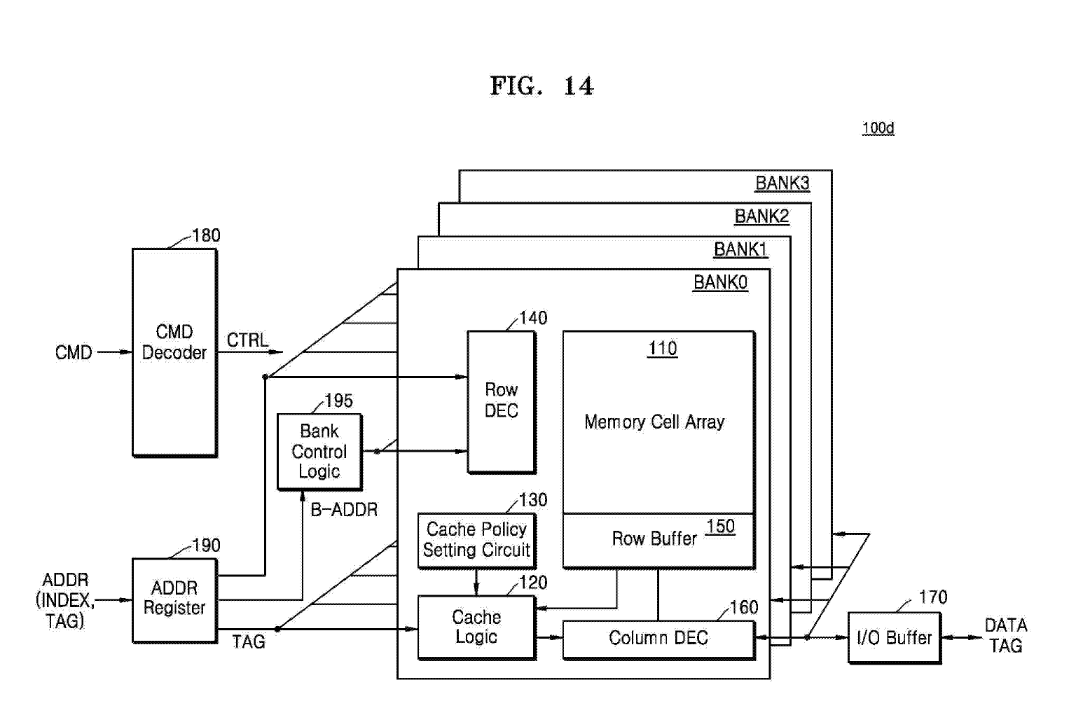

FIG. 14 is a block diagram of the memory device 100d according to exemplary embodiments. FIG. 14 illustrates another embodiment of the memory device 100 of FIG. 3. The components having the same reference numerals in the memory device 100 of FIG. 3 and the memory device 100d of FIG. 14 have the same operations, and thus, their descriptions will not be repeated.

Referring to FIG. 14, a memory device 100d may include a plurality of banks BANK0 to BANK3. Each of the plurality of banks BANK0 to BANK3 may include the memory cell array 110, the row decoder 140, the row buffer 150, the cache logic 120, the cache policy setting circuit 130, and the column decoder 160. Accordingly, each of the plurality of banks BANK0 to BANK3 may perform a cache operation based on a different cache policy. Meanwhile, in order to select one of the plurality of banks BANK0 to BANK3, the memory device 100d may include bank control logic 195. Some bits of an index INDEX received by the memory device 100d may be provided to the bank control logic 195 as a bank address B-ADDR. The bank control logic 195 may select at least one of the plurality of banks BANK0 to BANK3 based on the bank address B-ADDR. In this exemplary embodiment, although only four banks BANK0 to BANK3 are illustrated, the disclosure is not limited thereto.

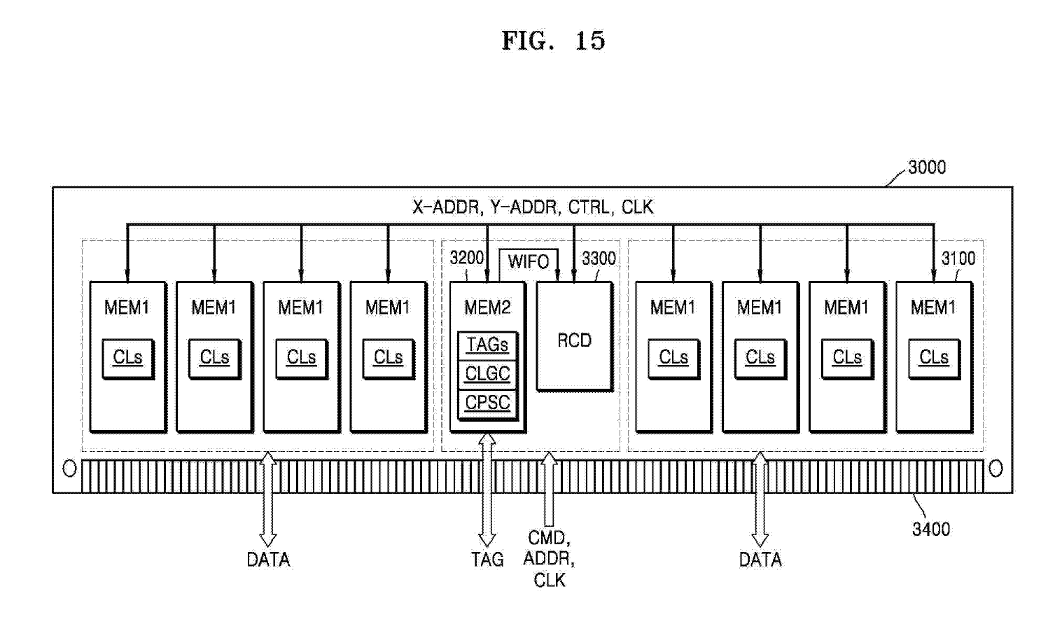

FIG. 15 is a view of a memory module 3000 according to an exemplary embodiment.

Referring to FIG. 15, the memory module 3000 may include a plurality of first memories 3100, at least one second memory 3200, a register (RCD) 3300, and a tap 3400. The memory module 3000 may be a registered dual in-line module (RDIM). FIG. 15 illustrates nine memories 3100 and 3200. However, the present inventive concept is not limited thereto. The number of memories 3100 and 3200 may be determined based on structures and I/O configurations of the memory module 3000.

The plurality of first memories 3100 may store a plurality of cache lines CLs. Each of the plurality of cache lines CLs may be stored in the plurality of first memories 3100 in a distributed fashion. In other words, bits of one cache line may be distributed and stored in the plurality of first memories 3100, and one first memory 3100 may store some bits of the plurality of cache lines.

The second memory 3200 may store a plurality of tags TAGs corresponding to the plurality of cache lines CLs. The second memory 3200 may include cache logic CLGC and a cache policy setting circuit CPSC. The cache policy setting circuit CPSC may set a cache policy and change the cache policy, as described according to the embodiments. The cache logic CLGC may determine a cache hit based on a tag included in an address ADDR, and when the cache hit occurs, provide way information WIFO in which a cache line corresponding to a matched tag is stored to the register 3300. When a cache miss occurs, the cache logic CLGC may select a victim cache line based on the cache policy and provide way information WIFO in which the victim cache line is stored to the register 3300.

The register 3300 may control general operations of the memory module 3000. The register 3300 may receive a clock CLK, a command CMD, and an address ADDR. The register 3300 may provide a clock CLK, a row address X-ADDR, and a control signal CTRL to the plurality of first memories 3100 and the second memory 3200. Also, the register 3300 may generate a column address Y-ADDR based on the way information WIFO received from the second memory 3200, and provide the generated column address Y-ADDR to the plurality of first memories 3100 and the second memory 3200.

The plurality of first memories 3100 may load cache lines CLs stored in a row corresponding to the row address X-ADDR provided from the register 3300 to an internal row buffer, and output data DATA of the cache line corresponding to the column address Y-ADDR from among the cache lines CLs loaded to the row buffer.

The second memory 3200 may load tags TAGs stored in the row corresponding to the row address X-ADDR to an internal row buffer and output the tag TAG corresponding to the column address Y-ADDR from among the tag TAGs loaded to the row buffer.

The tap 3400 may be formed in an edge portion of a substrate of the memory module 3000. The tap 3400 may include a connecting terminal that is also referred to as a tap pin, in a plural number. Command /address signal input pins, clock input pins, and data input/output signal pins may be assigned to the tap 3400.

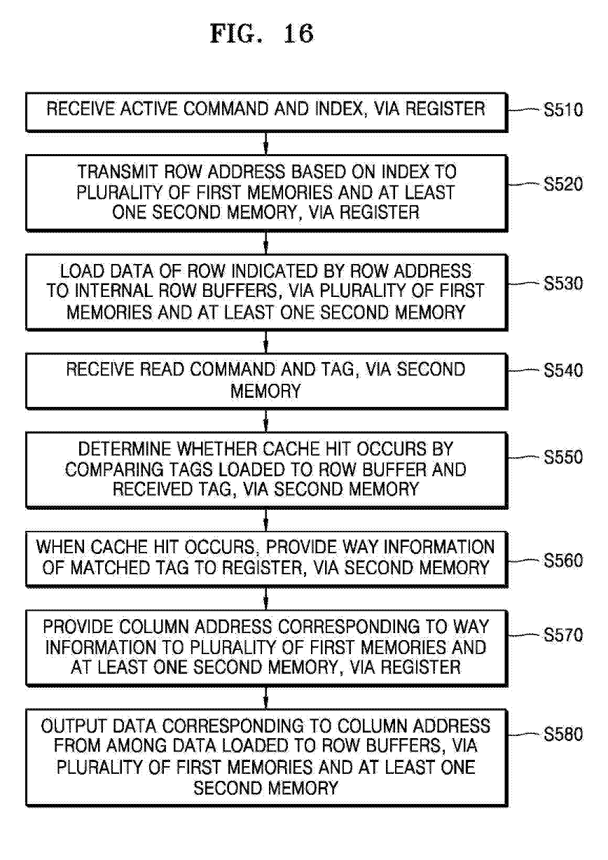

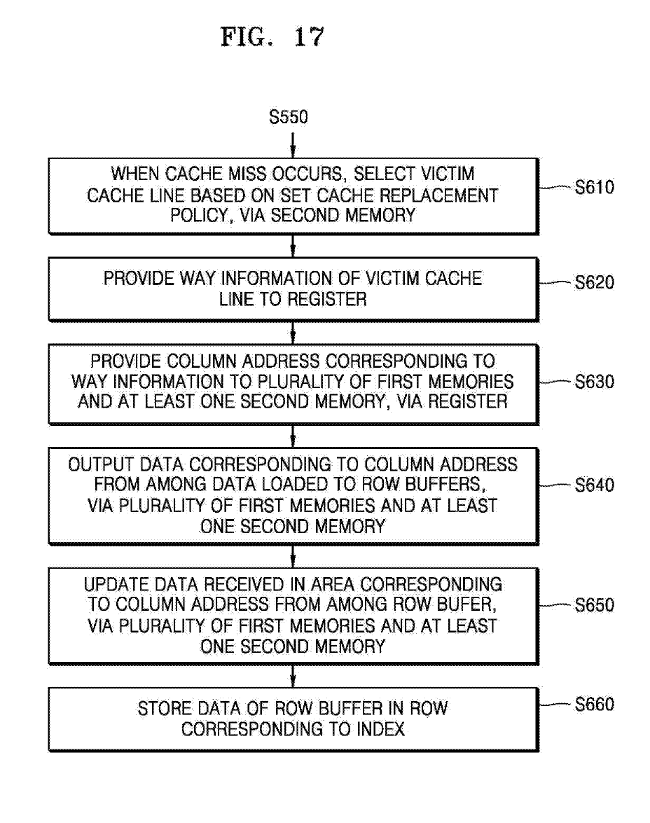

Hereinafter, an operation of the memory module 3000 of FIG. 15 will be described in more detail with reference to FIGS. 16 and 17.

FIGS. 16 and 17 are flowcharts of the operation of the memory module 3000 of FIG. 15.

Referring to FIG. 16, the register 3300 may receive an active command and an index in operation S510. The register 3300 may transmit a row address X-ADDR based on an index to the plurality of first memories 3100 and the at least one second memory 3200 in operation S520. Each of the plurality of first memories 3100 and the at least one second memory 3200 may load data of a row indicated by the row address X-ADDR to the internal row buffer in operation S530. The plurality of first memories 3100 may load a plurality of cache lines to the row buffer, and the second memory 3200 may load tags corresponding to the plurality of cache lines to the row buffer.

Thereafter, the second memory 3200 may receive a read command and a tag in operation S540. According to an embodiment, the second memory 3200 may directly receive a read command and a tag from the command /address signal input pins. According to another embodiment, the register 3300 may receive the read command and the tag and provide the received read command and tag to the second memory 3200.

The second memory 3200 may determine a cache hit by comparing the tags loaded to the row buffer and the received tag in operation S550. When the cache hit occurs, the second memory 3200 may provide way information WIFO of a matched tag (or way information WIFO of a cache line corresponding to the matched tag) to the register 3300 in operation S560.

The register 3300 may provide a column address Y-ADDR corresponding to the way information WIFO to each of the plurality of first memories 3100 and the second memory 3200 in operation S570.

The plurality of first memories 3100 and the second memory 3200 may output data corresponding to the column address Y-ADDR, from among data loaded to the row buffer, in operation S580. The plurality of first memories 3100 may output data DATA of a selected cache line, and the second memory 3200 may output a tag TAG corresponding to the selected cache line.

Referring to FIG. 17, when a cache miss occurs, the second memory 3200 may select a victim cache line based on a set cache replacement policy in operation S610, and provide way information WIFO of the victim cache line to the register 3300 in operation S620.

The register 3300 may provide the column address Y-ADDR corresponding to the way information WIFO to each of the plurality of first memories 3100 and the second memory 3200 in operation S630. When the victim cache line is in a dirty state, the cache line has to be stored in main memory, and thus, each of the plurality of first memories 3100 and the second memory 3200 may output data corresponding to the column address Y-ADDR, from among the data loaded to each row buffer. That is, each of the plurality of first memories 3100 and the second memory 3200 may output data and a tag of the victim cache line in operation S640. The output data or tag of the victim cache line may be provided to the memory controller or the main memory.

Thereafter, each of the plurality of first memories 3100 and the second memory 3200 may load the received data or tag to an area of each row buffer, which corresponds to the column address Y-ADDR, in operation S650, and may store data of each row buffer in a row corresponding to an index in order to replace the cache line in operation S660.

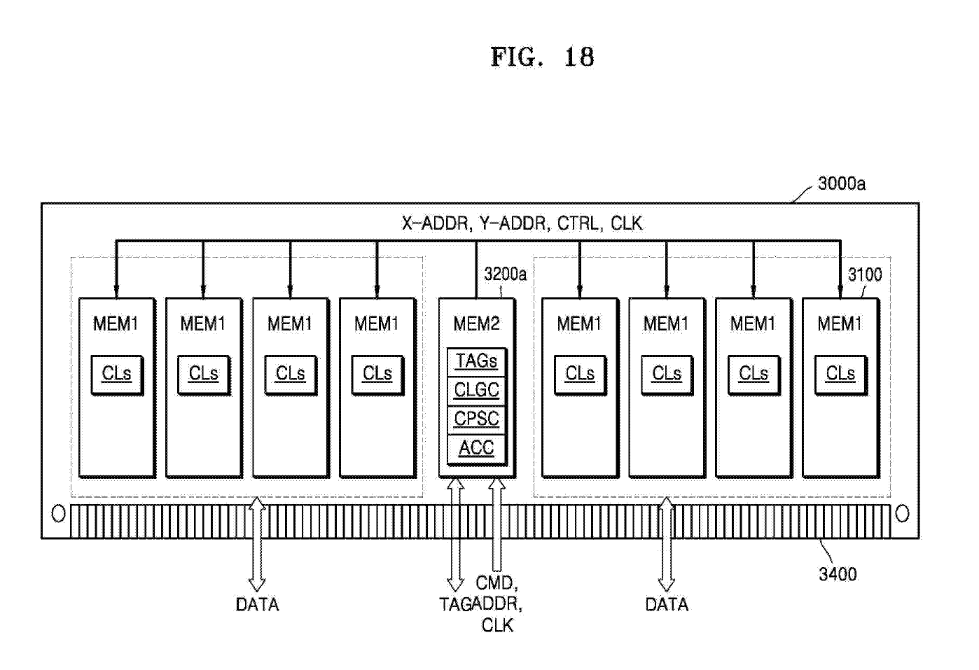

FIG. 18 is a view of a memory module 3000a according to an exemplary embodiment. FIG. 18 illustrates another embodiment of the memory module 3000 of FIG. 15.

Operations of the plurality of first memories 3100 of the memory module 3000a may be same as the operation of the plurality of first memories 3100 of the memory module 3000 of FIG. 15, and thus, their descriptions will not be repeated.

The memory module 3000a may include at least one second memory 3200a, and the second memory 3200a may store a plurality of tags TAGs, and may include the cache logic CLGC, the cache policy setting circuit CPSC, and an address conversion circuit ACC. The address conversion circuit ACC may perform some of functions of the register 3300 of FIG. 15. The address conversion circuit ACC may receive an address signal ADDR and generate a row address X-ADDR based on an index included in the address signal ADDR. Also, the address conversion circuit ACC may generate a column address Y-ADDR based on way information of a selected cache line. The second memory 3200a may provide the row address X-ADDR, the column address Y-ADDR, a clock CLK, and a control signal CTRL to the plurality of first memories 3100.

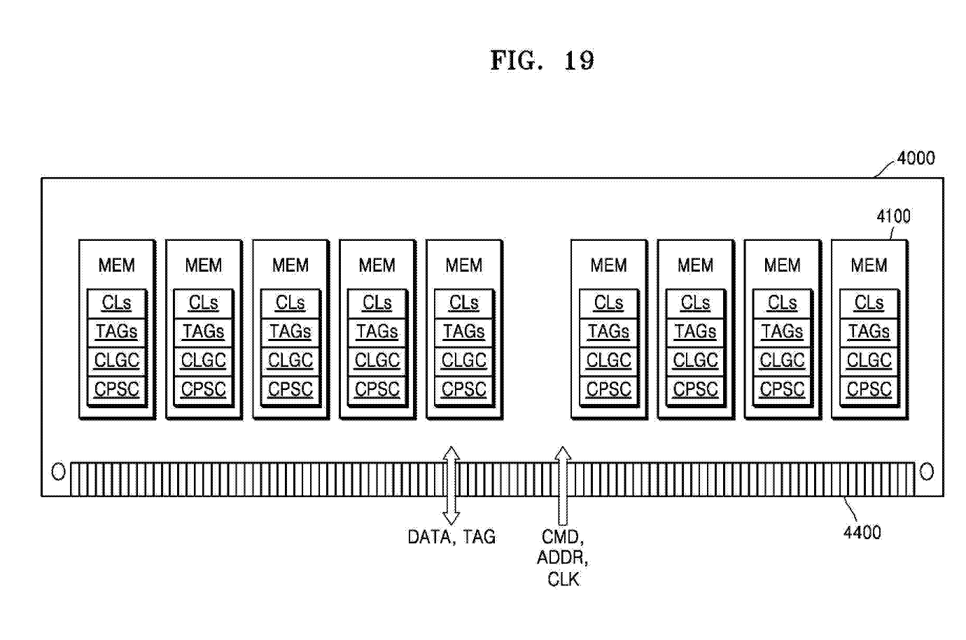

FIG. 19 is a view of a memory module 4000 according to an exemplary embodiment.

Referring to FIG. 19, the memory module 4000 may include a plurality of memories 4100. The memory module 4000 may be a load reduced dual in-line module (LRDIM). FIG. 15 illustrates that the memory module 4000 includes nine memories 4100. However, the present inventive concept is not limited thereto. The number of memories 4100 may be determined based on structures and I/O configurations of the memory module 4000.

Each of the memories 4100 may store the plurality of cache lines CLs and the plurality of tags TAGs corresponding to the plurality of cache lines CLs. Each of the memories 4100 may include the cache logic CLGC and the cache policy setting circuit CPSC.

According to an exemplary embodiment, each of the plurality of cache lines CLs and the plurality of tags TAGs may be stored in the plurality of memories 4100 in a distributed fashion. For example, bits of one cache and one tag may be distributed and stored in the plurality of memories 4100 and one memory 4100 may store some bits of the plurality of cache lines and the plurality of tags. The plurality of memories 4100 may receive the same index and tag and operate in the same way.

According to another exemplary embodiment, different cache lines and tags TAGs may be stored in the plurality of memories 4100. In other words, the memory device 100 of FIG. 2 may be applied to the plurality of memories 4100, and each of the plurality of memories 4100 may separately operate.

As shown above, the memory modules 3000, 3000a, and 4000 according to the embodiments have been described with reference to FIGS. 15 through 19. However, the memory modules 3000, 3000a, and 4000 are exemplary, and structures and operations of the memory module may be changed in various ways within the technical scope of the present inventive concept.

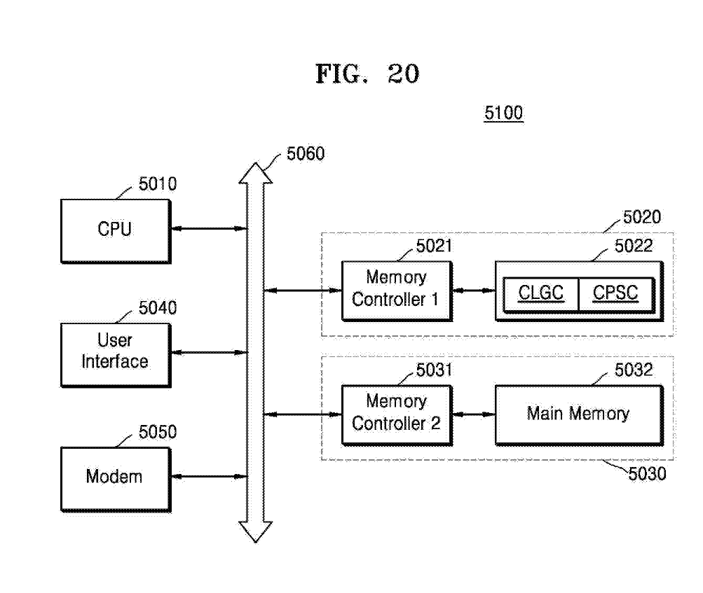

FIGS. 20 through 22 are block diagrams of a computing system according to exemplary embodiments.

Referring to FIG. 20, the computing system 5100 may include a CPU 5010, a first memory system 5020, a second memory system 5030, a user interface 5040, a modem 5050, and a bus 5060. In addition, the computing system 5100 may further include various other components. The first memory system 5020, the second memory system 5030, the user interface 5040, and the modem 5050 may be electrically connected to the bus 5060 and may exchange data and signals with one another via the bus 5060.

The CPU 5010 may perform calculations and data processing and controlling of the computing system 5100.

The first memory system 5020 may include a first memory controller 5021 and cache memory 5022. The memory system 1500 of FIG. 2 may be applied as the first memory system 5020. The first memory controller 5021 may provide an interface between the cache memory 5022 and the other components of the computing system 5100, for example, the CPU 5010, the user interface 5040, or the modem 5050.

The memory device or the memory module described with reference to FIGS. 2 through 19 may be applied as the cache memory 5022. The cache memory 5022 may include the cache logic CLGC and the cache policy setting circuit CPSC. According to an embodiment, the cache memory 5022 may read and write data based on a page. According to an embodiment, the cache memory 5022 may include a DRAM cell.

The second memory system 5030 may include a second memory controller 5031 and main memory 5032. The second memory controller 5031 may provide an interface between the main memory 5032 and the other components of the computing system 5100. The main memory 5032 may include a memory cell array homogeneous or heterogeneous with the cache memory 5022. An operating speed of the main memory 5032 may be equal to or less than an operating speed of the cache memory 5022. According to an embodiment, the main memory 5032 may include a nonvolatile memory cell.

The user interface 5040 may exchange signals with the outside of the computing system 5100. For example, the user interface 5040 may include user input interfaces, such as a keyboard, a keypad, a button, a touch panel, a touch screen, a microphone, a vibration sensor, etc. The user interface 5040 may include user output interfaces, such as a liquid crystal display (LCD), an organic light-emitting diode (OLED), an active matrix OLED (AMOLED), a light-emitting diode (LED), a speaker, a motor, etc.

The modem 5050 may perform wireless or wired communication with an external device according to control of the CPU 5010. The modem 5050 may perform communication based on at least one of various communication standards, such as Wifi, code division multiple access (CDMA), global system for mobile communication (GSM), long-term evolution (LTE), Bluetooth, near-field communication (NFC), etc.

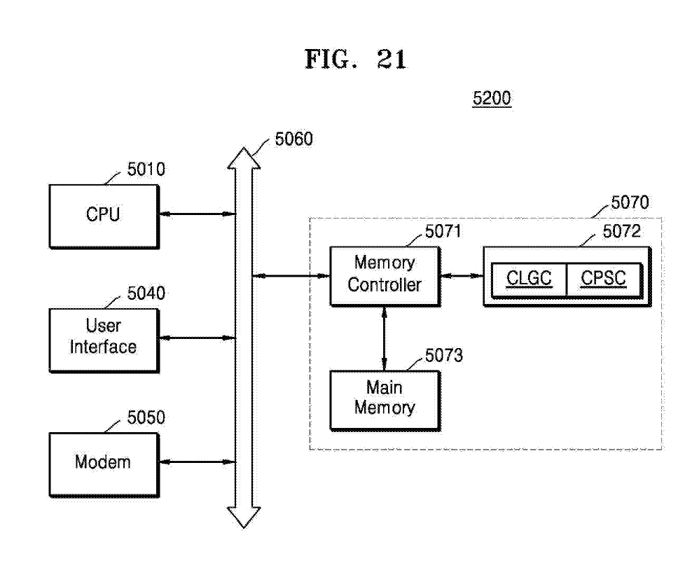

Referring to FIG. 21, the computing system 5200 may include the CPU 5010, a memory system 5070, the user interface 5040, the modem 5050, and the bus 5060.

The memory system 5070 may include a memory controller 5071, cache memory 5072, and main memory 5073. The cache memory 5072 may include the memory device or the memory module described with reference to FIGS. 2 through 19. As illustrated in FIG. 21, the memory controller 5071 may provide an interface with respect to the cache memory 5072 and the main memory 5073, and control the cache memory 5072 and the main memory 5073. As shown above, the cache memory 5072 and the main memory 5073 may be controlled by the same memory controller.

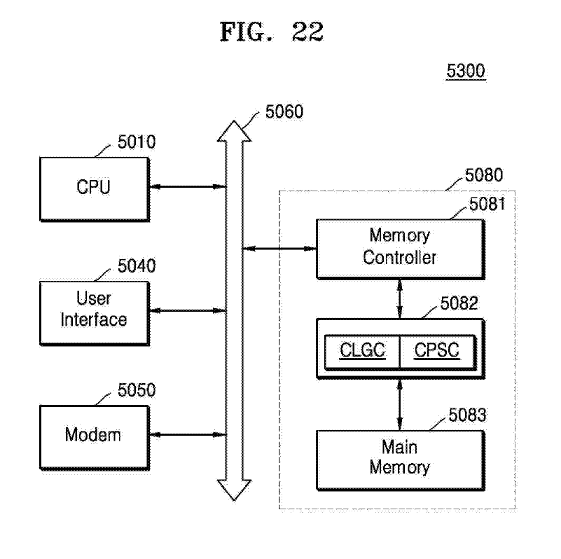

Referring to FIG. 22, a computing system 5300 may include the CPU 5010, a memory system 5080, the user interface 5040, the modem 5050, and the bus 5060. The memory system 5080 may include a memory controller 5081, cache memory 5082, and main memory 5083. The cache memory 5082 may include the memory device or the memory module described with reference to FIGS. 2 through 19. The cache memory 5082 and the main memory 5083 may be controlled by the memory controller 5081. The cache memory 5082 and the main memory 5083 may be connected to the same channel, that is, the same data transmission line, as illustrated in FIG. 22. Accordingly, when data is exchanged between the cache memory 5082 and the main memory 5083, such as when a cache line is replaced, the data may be directly transmitted and received between the cache memory 5082 and the main memory 5083, without passing through the memory controller 5081.

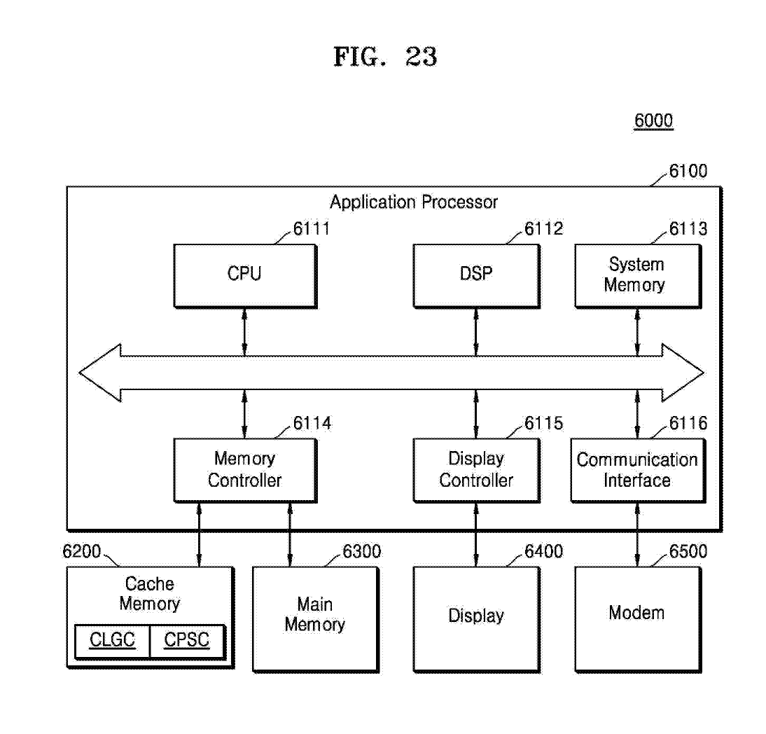

FIG. 23 is a block diagram of a mobile system 6000 according to an exemplary embodiment.

Referring to FIG. 23, the mobile system 6000 may include an application processor 6100, cache memory 6200, main memory 6300, a display 6400, and a modem 6500.

The application processor 6100 may control operations required to be executed in the mobile system 6000. The application processor 6100 may include a CPU 6111, a digital signal processor (DSP) 6112, a system memory 6113, a memory controller 6114, a display controller 6115, a communication interface 6116, and a bus electrically connecting the CPU 6111, the DSP 6112, the system memory 6113, the memory controller 6114, the display controller 6115, and the communication interface 6116. According to an embodiment, the application processor 6100 may be realized as a system on chip (SoC).

The CPU 6111 may perform calculations and data processing and controlling of the application processor 6100. The DSP 6112 may perform digital signal processing at high speed, and partially perform calculation, and data processing and controlling of the application processor 6100.

The system memory 6113 may load data required for an operation of the CPU 6111. The system memory 6113 may be realized as SRAM, DRAM, MRAM, FRAM, RRAM, etc.

The memory controller 6114 may provide an interface between the application processor 6100, and the cache memory 6200 and the main memory 630. The main memory 6300 may be used as an operation memory of the application processor 6100. For example, data according to an application execution in the application processor 6100 may be loaded to the main memory 6300. According to an embodiment, the main memory 6300 may be a nonvolatile memory.

The cache memory 6200 may include the memory device or the memory module described with reference to FIGS. 2 through 19. The cache memory 6200 may dynamically change the cache policy according to a use environment, and thus, the performance of the mobile system 6000 and the reliability of the main memory 6300 may be increased.

FIG. 23 illustrates that the memory controller 6114 is connected to the main memory 6300 and the cache memory 6200. However, the present inventive concept is not limited thereto. The application processor 6100 may further include an additional memory controller controlling the cache memory 6200.

The display controller 6115 may provide an interface between the application processor 6100 and the display 6400. The display 6400 may include a flat display or a flexible display, such as a touch screen, an LCD, an OLED, an AMOLED, an LED, etc.

The communication interface 6116 may provide an interface between the application processor 6100 and the modem 6500. The modem 6500 may support communication using at least one of various communication protocols, such as Wifi, LTE, Bluetooth, radio frequency identification (RFID), infrared data association (IrDA), ultra wideband (UWB), Zigbee, Wi-fi direct (WFD), NFC, etc. The application processor 6100 may communicate with other electronic devices or other systems, via the communication interface 6116 and the modem 6500.

While the inventive concept has been particularly shown and described with reference to embodiments thereof, it will be understood that various changes in form and details may be made therein without departing from the spirit and scope of the following claims.

1. A memory device comprising:
a cell array storing a plurality of cache lines and a plurality of tags corresponding to the plurality of cache lines;
a cache policy setting circuit selecting from a plurality of managing policies at least one managing policy and setting a cache policy based on the at least one selected managing policy; and
cache logic managing the plurality of cache lines based on the cache policy.

2. The memory device of claim 1, wherein the cache policy setting circuit changes the cache policy by selecting from the plurality of managing policies at least another one of the plurality of managing policies based on a command received from an external device.

3. The memory device of claim 1, wherein the cache policy setting circuit changes the cache policy in response to a cache policy setting command received from an external memory controller.

4. (canceled)

5. The memory device of claim 1, wherein the cache policy setting circuit is configured to:
monitor an access command received from an external memory controller;
analyze an operation pattern or workload requested for the memory device based on a result of the monitoring of the access command; and
change the cache policy based on a result of the analysis of the operation pattern or workload requested for the memory device.

6. The memory device of claim 1, wherein the cache policy setting circuit comprises:
a policy selector selecting at least one of the plurality of managing policies; and
a policy register storing information with respect to the at least one selected managing policy.

7. The memory device of claim 6, wherein the cache policy setting circuit further comprises a monitor circuit monitoring an access command received by the memory device or data input and output and analyzing an operation pattern requested for the memory device.

8.-10. (canceled)

11. The memory device of claim 1, wherein the cell array comprises a plurality of rows, and each of the plurality of rows stores the plurality of cache lines and the plurality of tags corresponding to the plurality of cache lines.

12. The memory device of claim 11, further comprising a row buffer loading the plurality of cache lines and the plurality of tags stored in a row selected from among the plurality of rows based on a received index,
wherein the cache logic determines whether a cache hit occurs, based on the plurality of tags that are loaded and a received tag.

13. The memory device of claim 12, wherein when the cache hit occurs, the cache logic selects one of the plurality of cache lines based on a way of a tag from among the plurality of tags, which is matched with the received tag, and
when a cache miss occurs, the cache logic selects a victim cache line to be replaced from among the plurality of cache lines, based on the cache policy.

14. (canceled)

15. (canceled)

16. A memory module comprising:
a plurality of first memory devices storing a plurality of cache lines; and
a second memory device storing a plurality of cache tags corresponding to the plurality of cache lines, selecting from a plurality of managing policies at least one managing policy as a cache policy, and managing the plurality of cache lines based on the cache policy and the plurality of cache tags.

17. The memory module of claim 16, wherein the second memory device changes the cache policy by selecting from the plurality of managing policies another one of the plurality of managing policies based on a cache setting command or an operation command that is received.

18. The memory module of claim 16, wherein the plurality of first memory devices and the second memory device receive same index and load the plurality of cache lines and the plurality of cache tags of a row corresponding to the index onto row buffers provided in the plurality of first memory devices and the second memory device, respectively.

19. The memory module of claim 16, wherein the second memory device comprises:
a cell array storing the plurality of cache tags;
a cache policy setting circuit setting the cache policy based on the plurality of managing policies; and
cache logic determining whether a cache hit occurs and selecting one of the plurality of cache lines based on the cache policy.

20. The memory module of claim 19, further comprising a register receiving way information of the selected cache line from the second memory device and providing a row address with respect to the way information to the plurality of first memory devices.

21. The memory module of claim 19, wherein the second memory device further comprises an address conversion circuit generating a row address based on way information of the selected cache line received from the cache logic and providing the row address to the plurality of first memory devices.

22.-25. (canceled)

26. An operating method of a memory device, the operating method comprising:
managing a plurality of cache lines based on a pre-set cache policy;
receiving a cache policy setting command from a memory controller external to the memory device;
changing the pre-set cache policy by selecting from a plurality of managing policies a managing policy as a new cache policy for operating the memory device when a cache policy based on the received cache policy setting command is different from the pre-set cache policy; and
managing the plurality of cache lines based on the new cache policy.

27. The operation method of claim 26, wherein the changing of the pre-set cache policy comprises:
monitoring an access command received from the memory controller;
analyzing an operation pattern or workload requested for the memory device based on a result of the monitoring of the access command; and
changing the pre-set cache policy to the new cache policy based on a result of the analysis of the operation pattern or workload requested for the memory device.

28. The operation method of claim 26, wherein when a write request with respect to the memory device during a predetermined time period is determined as equal to or higher than a threshold value, selecting a managing policy for selecting a clean cache line from among the plurality of cache lines as a replacement cache line.

29. The operation method of claim 26, wherein the plurality of managing policies comprise at least one of a plurality of replacement policies, a plurality of assignment policies, and a plurality of write policies.

30. (canceled)

31. The operation method of claim 26, wherein the memory device is a cache memory arranged between the memory controller and a main memory, wherein a portion of data stored in the main memory is copied to the cache memory.
